(19) United States
(12) Patent Application Publication
(10) Pub. No.: US 2002/0101207 A1
(43) Pub. Date: Aug. 1, 2002

(54) Cathode ray tube of the index tube type

(76) Inventors: Petrus Johannes Gerardus Van Lieshout, Eindhoven (NL); Pieter Johannes Engelaar, Eindhoven (NL); Anthonie Hendrik Bergman, Eindhoven (NL)

Correspondence Address: Corporate Patent Counsel, U.S. Philips Corporation, 580 White Plains Road, Tarrytown, NY, 10591, US

(21) Appl. No.: 10/014,236

(22) Filed: Dec. 11, 2001

(30) Foreign Application Priority Data
Dec. 18, 2000 (EP) 00204636.5

(51) Int. Cl. H01J 25/10

(52) U.S. Cl. 315/399

(57) ABSTRACT

Picture display device comprising a cathode ray tube of the index type having a pattern of electrodes (16, 17), comprising a central part and a peripheral part. During operation an index signal is produced. The device has means (34) for extracting lower frequency data of the peripheral part and higher frequency data of the central part of the pattern from the index signal.

### DESCRIPTION OF THE PRIOR ART

The invention relates to a picture display device comprising a cathode ray tube having means for generating one or more electron beams, a display screen provided with conducting index elements inside an evacuated envelope, and means for deflecting the electron beams across the display screen and over the index elements, the picture display device comprising receiving means for receiving data emanating from the index elements, and means for controlling first and higher order errors in the deflection and/or shape of the electron beam(s) in response to said data.

Picture display devices of the index type are known and are usually referred to as ‘index’ display devices. As compared with the conventional picture display device, in which the cathode ray tube is provided with a colour selection electrode (also referred to as shadow mask), such index display devices have the advantage of a smaller weight due to the absence of the shadow mask. They require less energy and the sensitivity to vibrations and temperature differences and variations is reduced. This is offset by the fact that, due to the absence of the shadow mask, the sensitivity to disturbing effects of parasitic (electro)magnetic fields, including the earth's magnetic field, is much greater, and much more stringent requirements are imposed on the accuracy with which the beams are generated and deflected.

To obviate and/or reduce the above-mentioned drawbacks, the display screen of an index display device is provided with index elements with which the position and/or the shape of the electron beam(s) can be controlled while they are being deflected across the display screen and over the index elements, which control data are used to correct the deflection and/or shape of the electron beam(s). To improve the control of the deflection and/or shape, it has been proposed in International patent application no WO 00/38212 to use more than one pattern of index elements, one pattern extending across the visible area of the display screen and at least one other pattern extending in at least two corners of the display screen. The signals of the latter pattern provide data which indicate, and can be used for, the control or correction of relatively large-scale, i.e. lowest order and lower frequency errors, e.g. global errors such as rotation of the raster and aspect ratio of the raster and straightness of the raster along the periphery of the central, visible area. The signals of the first pattern, the one in the visible area of the display screen, provide data which are indicative of, and can be used for, controlling or correcting higher order and/or higher frequency errors. Within the concept of the invention, higher and lower order or frequency data relate to temporal and/or spatial frequency. Low order and low frequency data relate to effects having a spatial extent comparable to the display screen or a substantial part of the display screen, or to effects at a frequency lower than the frame or line frequency, whereas higher order or frequency data relate to effects having a spatial extent comparable to less than approximately ½ of the dimension of a display screen or at a frequency higher than the frame or line frequency.

The advantage of splitting the data is that global (low order or low-frequency errors) can be corrected by relatively simple means, such as relatively simple correction coils or correction currents applied to the deflection coils to rotate the raster or correct pincushion or barrel distortion of the raster. By aligning the raster and removing the low-order errors, remaining higher order errors can be more easily measured and corrected. The resulting High-Frequency signals (HF-signals) and corrections are relatively small. Although the solution offered by the known device offers advantages, there are also disadvantages in that the design is relatively complex.

### SUMMARY OF THE INVENTION

It is an object of the invention to provide a display device of a simpler design.

To this end, the display device in accordance with the invention is characterized in that at least one pattern of index elements extends in a central area as well as in a peripheral area of the display screen, said pattern having feedthroughs and having such a shape or, in operation, the electron beam being formed or deflected across said pattern, such that, due to deflection of the electron beam(s) across the pattern, an index signal on the feedthroughs comprises components corresponding to lower and higher order error data, and in that the receiving means comprises means outside said envelope for extracting said lower and higher order error data from said index signal.

Different patterns, each electrically separated from each other, are present in the known device and are used to collect low and high-order error data. This design necessitates separate amplifiers and separate feedthroughs associated with each of these patterns. In the device in accordance with the invention, one pattern for collecting both low and higher order data is used. This offers the possibility of a common measuring means, a common amplification means and a reduction of the number of feedthroughs, i.e. a simplification of design. Unlike the known device, a distinction between the lower and higher order error data does not stem from the use of different electrically separate circuits with separate signals within the envelope, but from extracting data from the index signal. Although the provision of extracting means in itself complicates the design, an overall reduction of complexity is obtained.

The device preferably comprises an amplification means outside the envelope for amplification of the index signal. Having amplification means outside the envelope provides for a less complicated design and manufacturing than having amplification means inside the tube, e.g. due to a reduction of the number of feedthroughs as well as the production of energy within the tube.

The pattern of index element preferably comprises a sub-pattern mainly extending in the central area of the screen and a sub-pattern mainly extending in one or more peripheral areas of the screen, and the extracting means extract data corresponding to the impingement of the electron beam(s) on said sub-patterns.

These and other aspects of the invention are apparent from and will be elucidated with reference to the embodiments described hereinafter.

### BRIEF DESCRIPTION OF THE DRAWINGS

In the drawings:

FIG. 1 shows schematically a cathode ray tube,

FIG. 2 shows schematically a detail of a known picture display device,

FIG. 3 shows schematically a measuring circuit for a known picture display device,

FIG. 4 shows schematically a detail of a picture display device according to the invention,

FIG. 5 shows schematically a measuring circuit for a display device according to the invention,

FIG. 6 shows schematically a corner and upper side sensor for a display device according to the invention,

FIG. 7 illustrates gating signals for a display device according to the invention,

FIGS. 8 and 9 illustrate further embodiments of a display device according to the invention, and

FIGS. 10, 11, 12, 13A to 13C and 14 illustrate schematically further embodiments of the display device according to the invention.

The Figures are not drawn to scale. Generally, identical components are denoted by the same reference numerals in the Figures.

### DETAILED DESCRIPTION OF PREFERRED EMBODIMENTS

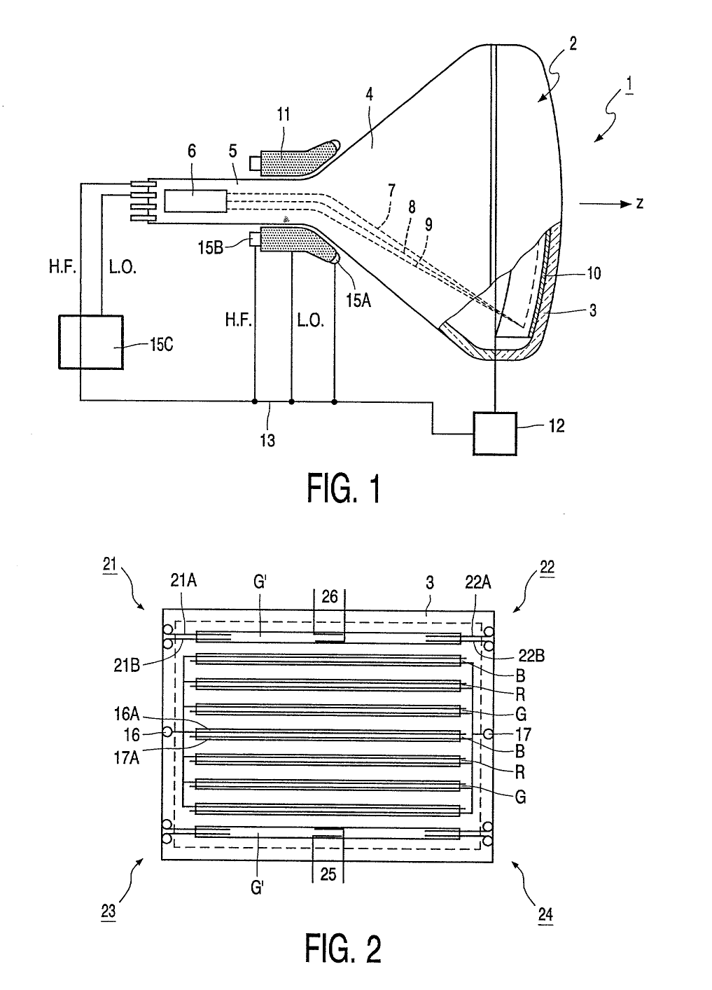

The cathode ray tube shown in FIG. 1 is a colour cathode ray tube 1 having an evacuated envelope 2 comprising a display window 3, a cone 4 and a neck 5. The neck 5 accommodates an electron gun 6 for generating one or more, in this example three, electron beams 7, 8 and 9 extending, in this embodiment, in one plane, the in-line plane. A display screen 10 is situated on the inner side of the display window 3. The display screen 10 comprises a plurality of red, green and blue-luminescing phosphor elements. Each group of (red, green or blue) phosphor elements forms a pattern. The display screen may also comprise other patterns such as a black matrix (a black pattern) or color filter patterns. Moreover, patterns are provided with index elements in cathode ray tubes of the index type. The signals emanating from said index elements as the electron beam(s) pass over them are indicative of the position and/or shape of the electron beam(s). These signals are sent to a means 12 for analysis. Usually, said means comprises means for deriving control signals 13 for controlling the deflection and/or shape of the electron beams which are sent to e.g. an additional coil 15A or 15B on the deflection unit 11 or to an electrode in or near the electron gun 6 via means 15C. The additional coil 15A may, for instance, be used to correct raster rotation, at a relatively low frequency (lower order correction), and a low-order correction (L.O.) may be sent to the deflection coils of the deflection unit for correction of raster size and pincushion or barrel distortion and/or seagull distortion. A high-order, i.e. high-frequency (H.F.) correction may be obtained by high-frequency coils 15B. Such correction coils are preferably of a relatively small size. The advantage of correcting high-frequency errors with a separate coil system and a separate signal is that the energy requirement is strongly reduced as compared with the use of one and the same system for both low and higher order (low and higher frequency) corrections. The means 15C supply a high-frequency (H.F.) signal to an electrode for correction of high-frequency errors, e.g. at video frequency, a low-frequency signal (L.O.) may be sent to another electrode for correction of low-frequency errors. Two types of errors are distinguished, those with a low frequency which include errors caused by, for instance, disturbing low-frequency electromagnetic fields, including the earth's magnetic field, misalignment of parts or thermal drift effects, in general errors that extend over an appreciable part of the screen, and those with a higher frequency or order which extend over a small part of the screen or vary rapidly. In preferred embodiments, the low-order errors are detected by the peripheral parts (which preferably extend for the greater part outside the visible area of the screen). The higher order and higher frequency errors are preferably detected by the central area of the pattern.

FIG. 2 shows schematically a detail of a picture display device as known from international patent application no. WO 00/38212. The picture display device comprises phosphor elements (red (R), green (G) and blue (B)) on a display window 3, and two electrodes 16 and 17, which have interpositioned fingers 16A and 17A. In addition to electrodes 16 and 17, which form a pattern of electrically conducting index elements, the picture display device also comprises further patterns 21, 22, 23, 24, each in a corner. In a simple embodiment, each patterns comprises two electrodes 21A and 21B etc. In the known display tube device, the patterns 21 to 24 are electrically separated from the patterns 16 and 17 and from each other. Low-order and low-frequency disturbances (caused by, for example, the earth's magnetic field) can be detected and corrected with the aid of patterns 21 to 24. Frame errors such as rotation and offset of the raster and/or barrel or pincushion distortions can thus be detected. The device may also comprise patterns 25 and 26 positioned along the upper and lower edge. Using these ‘coarse adjustment patterns’, the remaining high-frequency and high-order errors can be made relatively small. These errors are detected by the pattern comprising the electrodes 16 and 17.

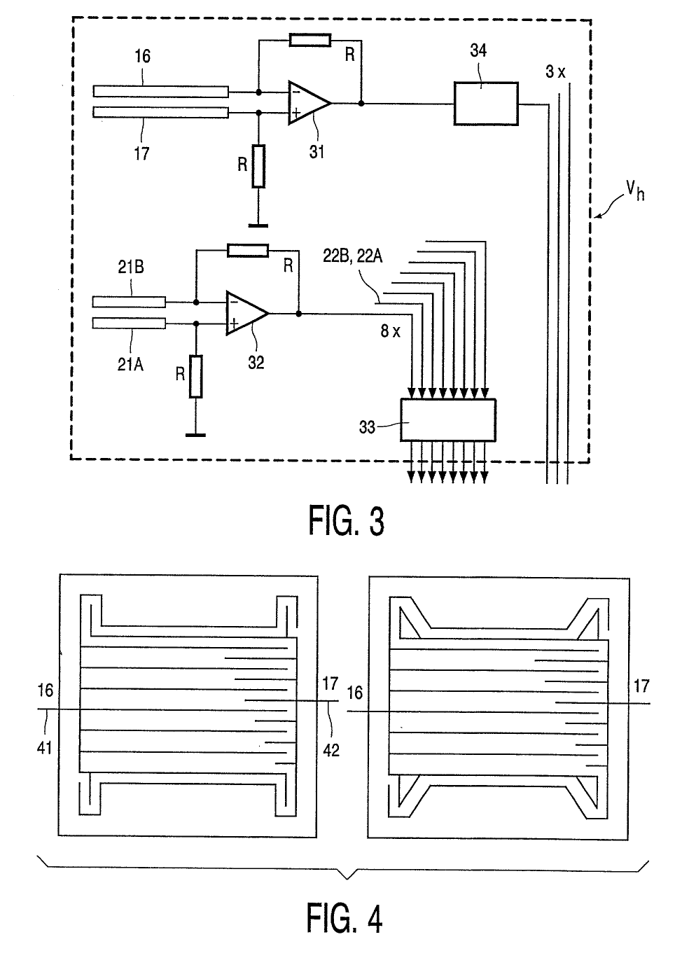

FIG. 3 shows schematically a circuit for measuring the position and/or shape of the electron beam(s) as known from WO 00/38212. Amplifier 31 amplifies the difference signal between the electrodes 16 and 17, amplifier 32 amplifies the difference signal between the electrodes 21A and 21B. Amplifiers are also provided for the difference signal between electrodes 22A and 22B etc. These signals are superimposed on the high voltage applied to the electrodes 16, 17, 21A, 21B etc. These electrodes are present on the display screen, which is generally at a high voltage, schematically denoted by Vh in FIG. 3. It is difficult and potentially hazardous (for the amplifiers) to perform measurements at such high voltages. The device therefore preferably comprises means 34 for conversion of a high-voltage signal into a low-voltage signal. It is difficult to have amplifiers as well as such means 34 inside the tube (since this would, for instance, require feedthroughs for the electrical supply of the amplifiers and means being led into the evacuated envelope). Even if this is done, the number of feedthroughs is large. Each feedthrough carries the risk of a leak and of a high-voltage hazard and complicates the design.

FIG. 4 schematically shows a detail of a device in accordance with the invention.

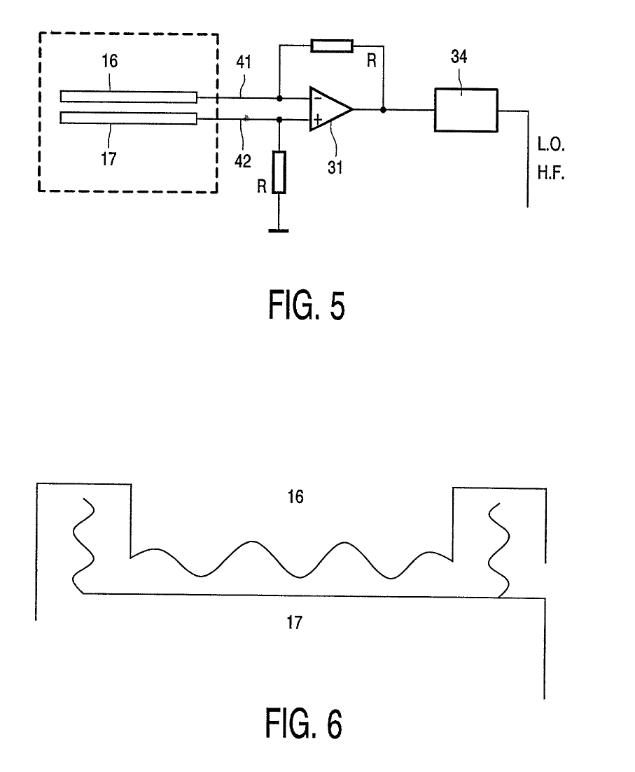

In the display device in accordance with the invention, the electrodes 16 and 17 are electrically interconnected to the corner electrodes, both sub-patterns form one pattern and subsequently the number of electrodes is reduced (to two in this example). Subsequently, the number of feedthroughs 41, 42 and the number of amplifiers are also reduced. The pattern extends in the central area of the screen as well as in the corner areas (it could also extend along an upper or lower side as shown in FIG. 4). The parts of the pattern extending in the peripheral area(s) preferably comprise parts which extend in two mutually transverse directions (x-y direction). In a most preferred embodiment, there is only one pattern, comprising only two electrodes. The number of feedthroughs and amplifiers or other circuits is then reduced as much as possible (two feedthroughs, one amplifier). Such a situation is schematically shown in FIG. 5 wherein the dotted rectangle indicates the evacuated envelope 2 and the feedthroughs 41 and 42 are indicated. The device preferably comprises, outside the envelope, an amplifier 31 for amplification of a signal from the pair of patterns, i.e. from electrodes 16 and 17. In some embodiments, this amplifier may be alternatively positioned inside the envelope. The amplified signal is sent to a device 34 which comprises means for extracting higher frequency or higher order data (H.F.) (emanating from the central part of the pattern) and lower frequency or lower order data (L.O.)(emanating from the corner parts of the pattern).

Such an extracting operation can be performed in a number of ways:

In embodiments of the invention, the corner parts of the pattern are given such a form that the signals are distinguishable, for instance, by giving the corner parts of the pattern a shape as shown in FIG. 6. Shapes as shown in FIG. 6 would introduce a modulation frequency in the signals emanating from the electrodes 16 and 17. By using a filter designed for such a modulation frequency, the signal emanating from the corner parts can be distinguished from the signal emanating from the central part of electrodes 16 and 17.

In embodiments of the invention, a modulation frequency is superimposed on the intensity of the electron beams, as they are deflected towards and across the corner parts of the pattern. This causes a modulation frequency to be superimposed on the signal emanating from the corner parts and, again, filter means are used to extract said signal.

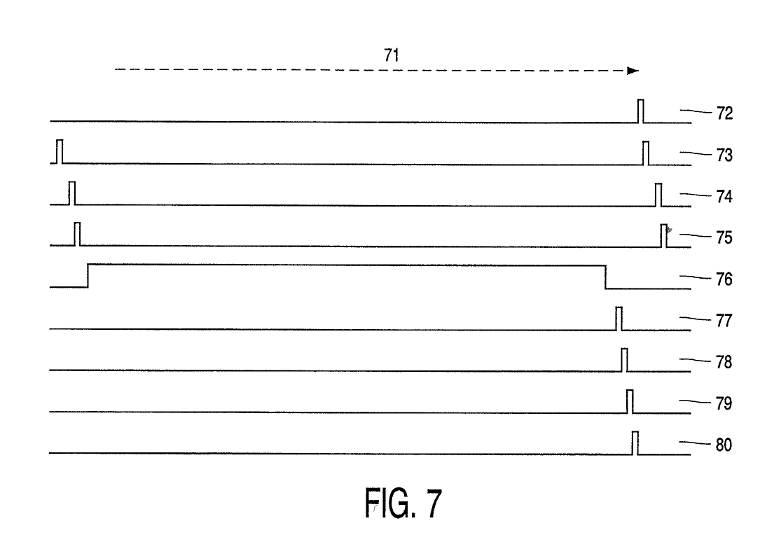

In embodiments, gating signals are sent to the means 34 to identify when the electron beam(s) are swept over the corner parts. The means 34 then include means for measuring the signals between or during said gating signals and attributing them to the relevant pair of patterns. FIG. 7 schematically shows such gating signals. During frame time 71, gating signals 72 and 73 indicate that the upper left corner is being scanned, signals 74 and 75 indicate that the upper right corner is being swept, signal 76 indicates that the central area of the pattern is being scanned, signals 77 and 78 indicate that the lower left corner is being scanned and, finally, signals 79 and 80 indicate that the lower right corner is being scanned. The advantage of such an embodiment is a signal increase as compared with the use of filter means, since filter means always involve signal losses.

It will be evident that many variations are possible within the scope of the invention.

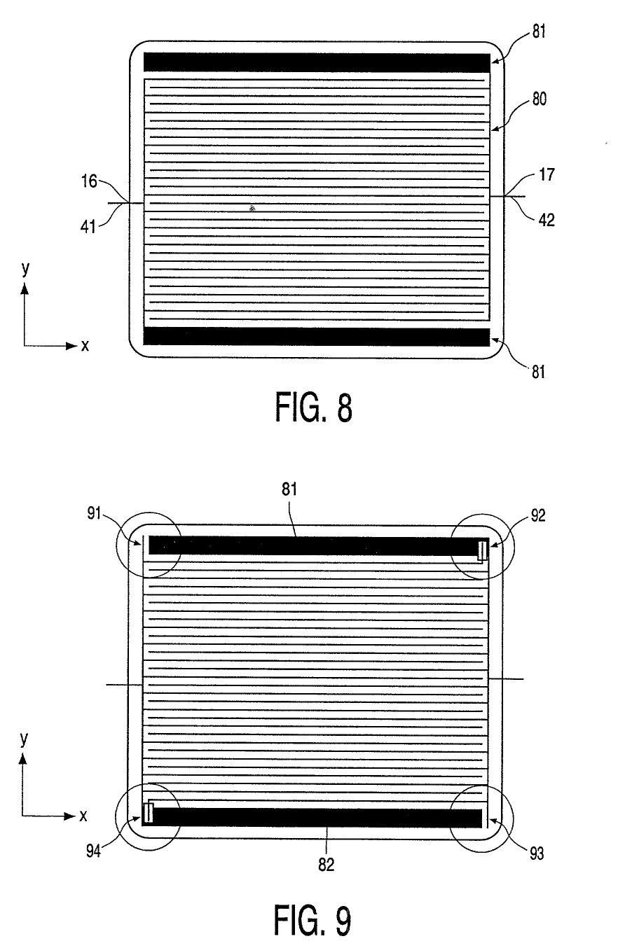

FIGS. 8 and 9 show two such variations.

FIG. 8 shows an advantageous embodiment in which the pattern comprises a tracking structure 80, in this example in the form of a comb structure in the central area of the screen, and a conductor 81 of substantially greater width than the diameter of the electron beams at either side of the central area tracking structure 80. This embodiment, having a broader lower and upper conductor, allows in particular easy retrieval of lower order tracking data as well as more advanced (higher order) tracking data. At the start-up, the embodiment ensures that the first and last line of the video signal coincide with the top and bottom conductors 81, respectively. This enables an automatic correction of said first line and last line to coincide with the desired vertical position of these lines. The amplitude of the signals on the electrodes needed for correct positioning gives information about the initial position and size of the raster, i.e. the low-order data relating to position and size of the raster. Using this knowledge, the (initial) position and size of the raster can be adapted to the deflection system and/or line-related interpolated signals can be added. One possible manner of effecting the corrections is to combine the standard vertical deflection together with a small signal HF vertical deflection coil (such as, for instance, coil 15B in FIG. 1). High-frequency tracking signals (stemming from the central part of the tracking structure) are fed to the HF deflector, low-frequency tracking signals are used for adaptation of the main deflection coils. Implementing such a combined deflection system results in an overall, relatively simple control system which is capable of handling all possible conditions. An advantage is also that a separate start-up algorithm can be omitted.

The simple structure as shown in FIG. 8 is, however, not directly suitable for providing horizontal position information (such as may be caused, for instance, by a horizontal raster translation). The structure as shown in FIG. 9 allows gathering of low-order horizontal positioning information. Corner sensor parts 91 to 94 are integrated in the design. As the electron beam(s) is (are) swept over the horizontally (i.e. transverse to the line direction) oriented gap between the conductors 81 and flanking parts of the other electrode at either side of the conductors 81, a signal is produced. When comparing the timing of the signals, information on the horizontal alignment of the raster is obtainable.

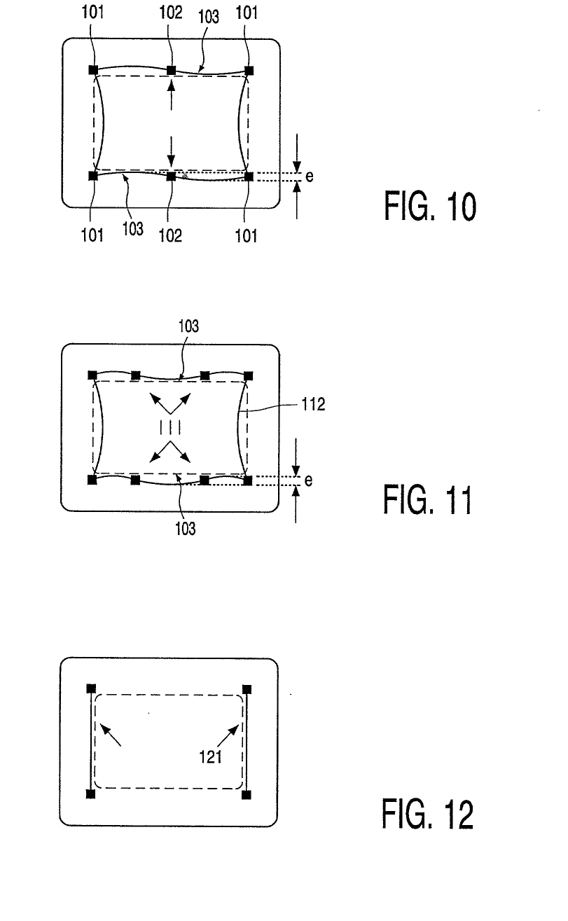

FIG. 10 schematically shows a device in which, next to corner sensors 101 also sensors 102 are used, which are located at the top and bottom of the screen just outside the visible area of the screen, indicated in FIG. 10 by the dotted lines. Such sensors are able to detect pincushion and barrel distortions of the raster. However, they are not able to detect distortions of the raster as schematically indicated by line 103. The non-linearity of the upper and lower lines may thus still be rather larger (indicated by e in FIG. 10). FIG. 111 schematically shows a device in accordance with the invention in which more than one position sensor 104 is located at each lower and upper side. The error is reduced. The display device allows such an addition of sensors relatively easily because the sensors are integrated in a simple structure. Addition of sensors does not require extra feedthroughs (and/or amplifiers), thus removing a practical obstacle. In the device, in which a detail of an embodiment of a device according to the invention is schematically indicated in FIG. 11, raster errors in the horizontal direction (schematically indicated by line 1 12) are not directly measurable. FIG. 12 shows an embodiment in which such errors are measurable by horizontal sensors 121 which comprise one or two vertical lines, placed outside the visible part of the screen in this relatively simple embodiment.

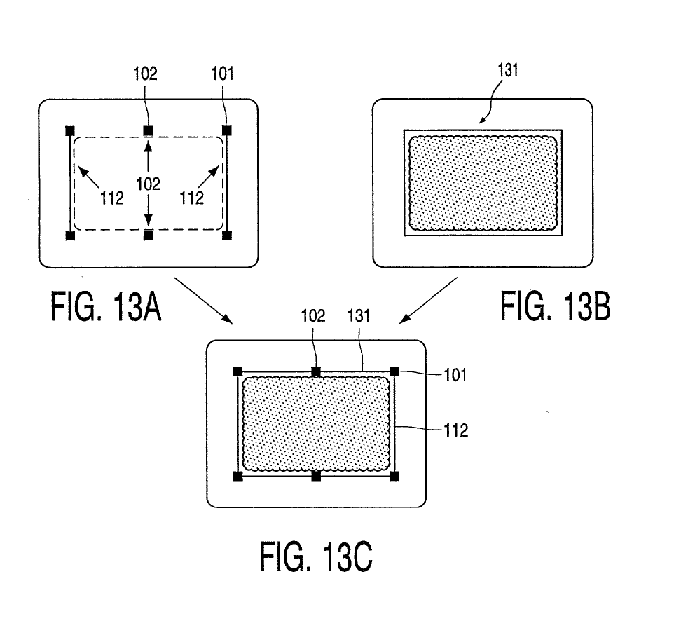

FIGS. 13A to 13C schematically show a preferred embodiment in which corner sensors 101, horizontal sensors 112 and side sensors 102 (FIG. 13A) are combined with a sensor comprising a rectangular frame 131 (FIG. 13B) to form a design as shown in FIG. 13C. One vertical side sensor 102 is used in said Figure. When a (very) non-linear vertical deflection unit is used, an extra V-sensor (see FIG. 11) can be added easily. It will be clear that all FIGS. 10 to 13C show in some detail the peripheral part of the integrated index pattern. The visible area (within the dotted lines) also comprises a central part of the index pattern, preferably a comb structure as shown e.g. in FIG. 4.

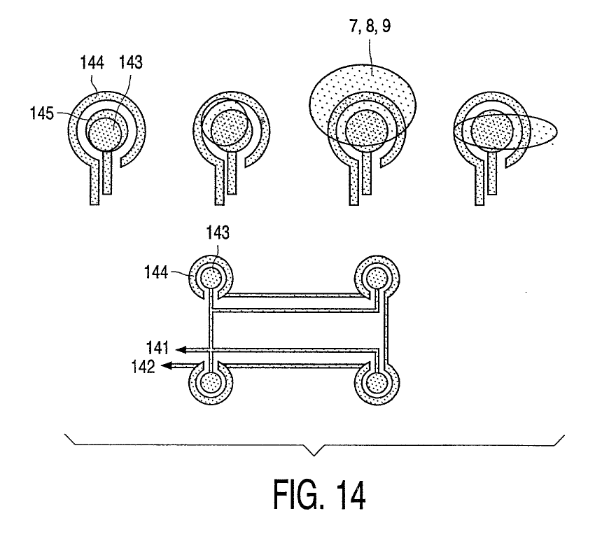

FIG. 14 shows schematically a preferred embodiment in which the sub-pattern (141, 142) extending in the peripheral parts of the screen comprises a set of sensor parts each comprising a central electrode part 143 whose shape corresponds to the general shape of an electron beam at the position where it is in focus (in this example circular), and is substantially encircled by an outer electrode part 144, said central and outer electrode parts being separated by a non-conducting zone 145. When the electron beam 7, 8, 9 is in focus, the signal on electrode 141 is maximised and the signal on electrode 142 is minimised. Consequently, either signal or a combination of the signals can be used for controlling the focus. Such an arrangement allows a fast and accurate control of the focus of the electron beams. It is noted that, in this example, said ‘eyelet’-shaped sensors are positioned in each corner and have a circular shape. The shape of the ‘eyelet’ 143 may be non-circular (for instance, oval) and this is the preferred shape of the electron beam when it is in focus at the position of the sensors. The sensors may be positioned at additional or different positions, although controlling the focus at least at or near the four corners of the screen is a preferred embodiment.

In summary, the invention may be described as follows.

A picture display device comprising a cathode ray tube of the index type having a pattern of electrodes, extending on a central part and on a peripheral part. During operation, an index signal is produced. The device has means for extracting data of the central and the peripheral part of the pattern from the index signal, the data of the peripheral part being used for correcting low-order errors, the data of the central part being used for correcting higher order errors.

1. A picture display device comprising a cathode ray tube (1) having means (6) for generating one or more electron beams (7, 8, 9), a display screen (10) provided with conducting index elements (16, 17) inside an evacuated envelope (2), and means (11) for deflecting the electron beams across the display screen and over the index elements, the picture display device comprising receiving means (12) for receiving data emanating from the index elements, and means for controlling (15A, 15B, 15C) lower and higher order errors in the deflection and/or shape of the electron beam(s) in response to said data, characterized in that at least one pattern of index elements extends in a central area as well as in a peripheral area of the display screen, said pattern having feedthroughs (41, 42) and having such a shape, or, in operation, the electron beam being formed or deflected across said pattern, such that, due to deflection of the electron beam(s) across the pattern, an index signal on the feedthroughs comprises components corresponding to lower and higher order error data, and in that the receiving means comprises means (34) outside said envelope (2) for extracting said lower and higher order error data from said index signal.

2. A device as claimed in claim 1, characterized in that the device comprises an amplification means (31) outside the envelope for amplification of the index signal.

3. A device as claimed in claim 1, characterized in that the pattern of index elements comprises a sub-pattern mainly extending in the central area of the screen and a sub-pattern mainly extending in one or more peripheral areas of the screen, and the extracting means extract data corresponding to the impingement of the electron beam(s) on said subpatterns.

4. A device as claimed in claim 1, characterized in that a part of the pattern extending in a peripheral area of the screen is formed such that the index signal comprises a modulation frequency when the electron beam(s) is (are) scanned across said screen.

5. A device as claimed in claim 1, characterized in that the device comprises a means for modulating the intensity of the electron beams such that the index signal comprises a modulation frequency when the electron beam is scanned across at least a peripheral part of the pattern.

6. A device as claimed in claim 1, characterized in that the device comprises means for supplying gating signals to the extracting means (34).

7. A device as claimed in claim 3, characterized in that the sub-pattern mainly extending in one or more peripheral areas of the screen comprises a broad conductor (81) aligned along the line direction, and has a substantially larger thickness than the dimension of the electron beam(s).

8. A device as claimed in claim 7, characterized in that the broad conductors are flanked on each side by a corner sensor part.

9. A device as claimed in claim 3, characterized in that the sub-pattern mainly extending in the peripheral area of the screen comprises focus sensor parts (143, 144) having a central electrode part (143) which is substantially encircled by an outer electrode part (144).

10. A picture display device comprising a cathode ray tube (1) of the index tube having a pattern of electrodes (16, 17), comprising a central part and a peripheral part, characterized in that, during operation, an index signal is produced and in that the device has means for extracting higher order error data of the central part of the pattern and lower order error data of the peripheral part of the pattern from said index signal.
